(19) United States
(12) Patent Application Publication
(10) Pub. No.: US 2024/0404082 A1
(43) Pub. Date: Dec. 5, 2024

(54) Passive Optical System To Determine The Trajectory Of Targets At Long Range

(71) Applicant: Pathfinder Systems, Inc., Lakewood, CO (US)

(72) Inventors: Ivan J. JASZLICS, Golden, CO (US); Sheila L. JASZLICS, Golden, CO (US)

(73) Assignee: Pathfinder Systems, Inc., Lakewood, CO (US)

(21) Appl. No.: 18/519,437

(22) Filed: Nov. 27, 2023

Related U.S. Application Data
(60) Provisional application No. 63/431,136, filed on Dec. 8, 2022.
(60) Provisional application No. 63/458,714, filed on Apr. 12, 2023.

(51) Int. Cl. G06T 7/246; G06T 7/277; G06T 13/20

(52) U.S. Cl. CPC G06T 7/248; G06T 7/277; G06T 13/20; G06T 2207/10016; G06T 2207/20084; G06T 2207/30241

(57) ABSTRACT

A passive optical system tracks and determines the trajectories of targets at long range. Potential targets are initially identified from video images from a moving platform (ownship). A state vector that includes the target bearing is calculated based on a time series of these video images. A number of “virtual twins” of the ownship are then launched by using a stochastic filter to generate updates of this state vector along a predetermined flight path continuing that of the ownship. After each launch, the flight path of the ownship is altered to thereby create a baseline separation. The trajectory of the target is estimated by triangulation based on the paths of the ownship and virtual twin, and the time series of bearing data from the ownship and virtual twin. By using frequent launches of virtual twins, the present system iteratively improves the target's predicted trajectory over long ranges.

### RELATED APPLICATIONS

The present application is based on and claims priority to the Applicant's U.S. Provisional Patent Application 63/431,136, entitled “Passive Optical System to Determine the Trajectory of Targets at Long Range,” filed on Dec. 8, 2022; and U.S. Provisional Patent Application 63/458,714, entitled “Passive Optical System to Determine the Trajectory of Targets at Long Range,” filed on Apr. 12, 2023.

### BACKGROUND OF THE INVENTION

### Field of the Invention

The present invention generally relates to the field of passive optical systems for determining the trajectory of targets at long ranges. More specifically, the present invention discloses a passive optical system for determining the trajectory of targets by creating virtual baselines with the aid of virtual twins. The invention also applies to collision avoidance, including non-cooperating, non-radiating targets. Its methods may be used for targeting by a cooperating group or swarm of aircraft or UAS,

### Background of the Invention

Tracking of unknown traffic (targets) from a single platform has been a long-standing problem. It can be traced back to World War II and Cold War submarine tactics, where the own platform (the submarine) attempted to determine the range and speed of the target (a surface vessel or another submarine) without using active sonar. Active sonar would have revealed the submarine's presence, making it vulnerable to countermeasures. One of the initial problems was the measurement of reliable parallax between two or more passive acoustic sensors. Initially, this was limited by the length of the submarine and the probabilistic nature of precise bearing measurements. U.S. Pat. No. 5,732,043 (Nguyen) presents a system that uses this approach to create a large, physical grid of acoustic sensors and an omnidirectional set of baselines. A different direction in solving the same problem was taken by J. J. Ekelund in 1958. Ekelund's approach did not require a baseline at first sight:

$${R}_{Ek} = ( {S}_{2} - {S}_{1} ) / ( {\dot{B}}_{1} - {\dot{B}}_{2} ) \qquad [ Equation 1 ]$$

where R_{EK} is the Ekelund range estimate. Instead, it created an implied single baseline by turning from Heading 1 (S₁) to a new heading (S₂). In Equation 1, the bearing rate when on Heading S₁ is designated \dot{B}₁; on Heading S₂, the bearing rate is \dot{B}₂. Ekelund's method assumed that the target continued on a constant heading and at a constant speed. The method itself is well known and is a subject of continued interest, even at the present time (Douglas Vinson Nance, A Simple Mathematical Model for the Ekelund Range, Computational Physics Notes, November 2023, TR-DVN-2023-3, Wright-Patterson AFB, Ohio).

In the 2000s, high-resolution video became universally available. Machine learning technology also advanced due to the availability of very large digital storage capabilities at low cost, with corresponding miniaturized, highly parallel digital processors. These advancements extended the potential application of passive ranging based on video imaging, including recognition and tracking of ground targets from aircraft.

Passive techniques have military and commercial significance alike. Passive ranging is inherently less costly than active ranging. The power required for active ranging is proportional to the fourth power of the range, or one may state that its required sensitivity grows with the fourth power of the range. The emitted power through the transmitter XMTR is proportional to the square of the range. The return wave reflected spherically from the target surface again requires power to reach the ownship's receiver (RCVR), proportional to the second power of the range. In contrast, the sensitivity required from a passive sensor increases with the second power of range. The sensitivity of passive sensing implies lower cost, a broader user base, smaller weight and size, and generally higher reliability due to its potential for mass production. The problem with passive ranging is that it requires more computational complexity than active ranging and is, therefore, more difficult to automate.

The essential problem with passive ranging is summarized as follows: Any bearing (and position) data are of limited accuracy and, therefore, should be regarded as a probabilistic variable. Modern inertial measuring devices have very low angular spread, with a standard deviation much less than 1 degree.

Another potential problem is the bias of the measurements. The bias may depend on temperature variations and manufacturing and installation errors in the inertial measuring unit (IMU). Bias is essentially a static value, whereas the time-variant measurements of target bearing are a probabilistic variable caused by various, apparently random sources that may change from video frame to video frame.

Because two directional measurements separated by a baseline are needed to fix a position, the parallax of the two measurements should greatly exceed the probabilistic angular spread of angular uncertainty, indicated as o. When the target, in reality, is in the given direction, the sensors may indicate a different angle. This difference may be due to sensor error, atmospheric aberration, or other reasons appearing as random errors.

The situation is more complex in three dimensions than what may be perceived from two-dimensional illustrations. FIG. 1 shows the principles of passive triangulation in three-dimensional space. Consider Camera A, located at point a and observing a target represented by the aircraft in that camera's field of view, and Camera B located at point b and observing the same target. Both observations are made at the same time tᵢ or are brought to the same time tᵢ by space-time correction algorithms.

In two-dimensional space, the position k of the target would be obtained by calculating the unknown values p and q from the line functions k and m in FIG. 1. By denoting unit vectors with bold underlined capitals (K, M), vectors with bold underlined lowercase letters (a, b, . . . ), and vector functions with bold lowercase with double underline (k, m):

$$\underline{\underline{k}} = \underline{a} + p \underline{K} \qquad [ Equation 2 ]$$

$$and$$

$$\underline{\underline{m}} = \underline{k} = \underline{b} + q \underline{M} \qquad [ Equation 3 ]$$

provide two simultaneous 3-dimensional vector equations, where K is the unit vector that points from the focal point of Camera A to the target, and M is the unit vector pointing at the target from the focal point of Camera B. Solving the two simultaneous equations will yield the values of p and q which in turn will yield the estimated target positions k and m.

Because of potential angular measurement errors, it is unlikely that the positions k and m will coincide in three dimensions. Instead, they will likely be separated by the miss distance n as seen in FIG. 1. Positions k and m will be at the point where vectors K, M, and n are mutually perpendicular, at the points where the miss distance function reaches its minimum. The angle δ in FIG. 1 shows the 3-dimensional parallax. This parallax must be significantly greater than the angular uncertainty of the measurements of the vectorial directions K and M to yield an acceptable miss distance estimate.

The wingspan of aerial vehicles is too small to result in practically useful baselines for large distances, limiting a two-camera approach to 1 or 2nautical miles. Consequently, many previous researchers have developed monocular distance and state vector estimation methods. These methods depend on recognizing the specific type of the target, then rotating and scaling a stored 3-dimensional target image to match the 2-dimensional image captured by video imaging (e.g., Ganguli et al., U.S. Pat. No. 9,342,746; Avadhanam et al., U.S. Pat. No. 10,235,577). These researchers' methods use current mathematical techniques but also present some problems.

Ganguli et al. and Avadhanam et al. recognize the probabilistic nature of video image capture and the process needed to extract the targets' position, direction, and velocity by iterative application of stochastic filtering techniques. By knowing the target's actual size and shape, the field of view of the camera, and the space occupied by the target image in each video frame, each single frame can provide a 3-dimensional range vector, that is, the unit vector pointing at the target direction, multiplied by the distance of the target from the ownship. Comparing the range vectors derived from consecutive video frames and knowing the time difference between each frame, the relative velocity vector of the target can be closely estimated with the help of recursive stochastic filters (e.g., the Kalman filter and its numerous varieties like the extended Kalman filter). A time history of the target trajectory and state vector can be generated. The Kalman filter is discussed by Kalman, R. E.: A New Approach to Linear Filtering and Prediction Problems, Journal of Basic Engineering, vol. 82, No. 1, pp. 35-45, 1960.

On the negative side, two apparent weaknesses are inherent in these monocular non-maneuvering state vector generation methods. First, for military use as a target motion estimator, these methods, based on specific shape recognition, may be misled by an opponent launching small, low-cost UAVs of the same external shape as the stored aircraft models. Because the range is derived solely from shape matching, and the method assumes that if a shape is matched, then the target is a known entity, this may be an effective countermeasure.

The second problem may be that the processing time required for each frame could be extensive compared to simpler methods and may limit applicability in small UAVs or projectiles. A minimum target image pixel size of around 70×30 (i.e., 2100) pixels or more seems to be required to ensure target identification.

### SUMMARY OF THE INVENTION

This invention provides a system for passively tracking one or more targets by sequences of images from a moving platform (ownship). The present system must identify only a generic target type such as aircraft, ship, ground vehicle, or spacecraft. By creating virtual baselines with the aid of virtual twins and using frequent launches of virtual twins, the present system captures and iteratively improves the target's state vector and near-term predicted trajectory over long ranges even when such trajectory is not a straight line.

The present system advances the state of the art in passive visual and infrared distance and target motion estimation by a single platform by introducing the concept of virtual twins of the camera sensors and launching a stream of virtual twins to provide real-time target motion estimation assisted by maneuvers of the single platform. The present system does not depend on the dimensions or well-defined shapes of specific target types. It thus avoids being deceived accidentally or intentionally by scale models of such specific types.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagram illustrating 3-D triangulation.

FIG. 2 is a system diagram of the present invention.

FIG. 3 is a flowchart of the present invention.

FIG. 4 is a diagram showing the components and interfaces of the physical camera array.

FIG. 5 is a diagram showing the initial phase of the life cycle of a Virtual Twin.

FIG. 6 is a diagram showing a Virtual Twin in phase II after the Ownship continues on a new heading.

FIG. 7 is a diagram showing a sequence of state vector estimates.

FIG. 8 is a diagram showing the operation and interfaces of the Virtual Twin software object.

FIG. 9 is a diagram showing the sequencing of Virtual Twins in the Virtual State Vector Sensor.

FIG. 10 is a diagram showing an example of Ownship and Target tracks.

FIG. 11 is a diagram illustrating an example of stochastic bearing calculations.

### DETAILED DESCRIPTION OF THE INVENTION

Glossary. The following words and phrases should be construed as
having the following meanings for the purpose of this disclosure:

| Abbreviation or Acronym | Description |
|---|---|
| AI Training System | Generates data for recognizing targets, not part of the invention |
| Baseline | Triangulation Baseline |
| Bearing and Elevation | The 3-D direction of a target from the ownship |
| CCSS | Communication and Control Subsystem of the invention |
| Coordinate Transform | Defines coordinates in one coordinate system in terms of another one |
| Digital Image | An image consisting of an array of pixels |
| Extended State Vector | State Vector, Errors, and forecast of future positions of the target |
| GGCS | Optional Gimbal and Gimbal Control System |
| Global Coordinate System | 3-D Coordinate system for the target and invention position and bearing |
| Initialization Data | Pre-defined data controlling the operation of the invention |
| IR, Infrared | Optical wavelengths from approximately 700 nm to 10,000 nm |
| Launch of a Virtual Twin (LVT) | Splitting off of a Virtual Twin on the ownship's heading, which it has learned |
| Miss Distance | The closest distance between two non-intersecting lines in 3-D space |
| Nanometer | 10⁻⁹ meters. 1 meter = 1,000,000,000 nm |
| NM | Nautical Mile |
| Object of Interest | A target |
| Optical Axis Vector | The 3-D direction aligned with a video or IR sensor's optical axis |
| Ownship | A platform or individual on which the present invention is mounted |
| Parallax | The angle between two lines in 3D space |
| Physical Baseline | Triangulation baseline between two physical image sensors |
| Physical Position Estimate | 3D position of a target estimated via the invention's physical image sensors |
| Pixel | A monochrome or multi-colored digital image element |
| Physical Camera Array, CA | The physical camera or cameras used by the invention |
| Range | The distance between the ownship and a target |
| Spatial triangulation | Estimating target position via direction vectors from the ends of a baseline |
| State Vector | Description of position, speed, and other target characteristics |
| Stochastic Filter | Creates probabilistic estimates of variables. Usually recursive. |
| System Events | Events within the invention |
| Target | An entity that the invention should track |
| Target Position Estimate | Stochastic estimate of most likely target position |
| Tracking | Observing and/or computing the target's state vector |
| Video Image Sensor | A video camera acquiring sequential digital images |
| View Angle (parallax) | Angle between the lines from the target to the two ends of the baseline |
| Virtual Assist Maneuver, VAM | A maneuver by the ownship to aid in generating a virtual baseline |
| Virtual Baseline (VB) | Triangulation baseline between a physical and a virtual image sensor |
| Virtual Bearing of Target (VBT) | The 3-dimensional bearing angle of the target, as seen from the Virtual Twin |
| Virtual Position | The 3-dimensional position of the Virtual Twin |
| Virtual State Vector Sensor | A software component sensing the state vector of the target |
| Virtual Target Position | Estimated 3D position of the target |
| Virtual Twin | Algorithm computing target direction, range, and short-term forecast |
| Virtual Twin Array, VT | The Virtual Twin Objects currently active in the invention |
| VMS | Video Management Subsystem |
| VS², VS2 | Abbreviations for the Virtual State Vector Sensor |

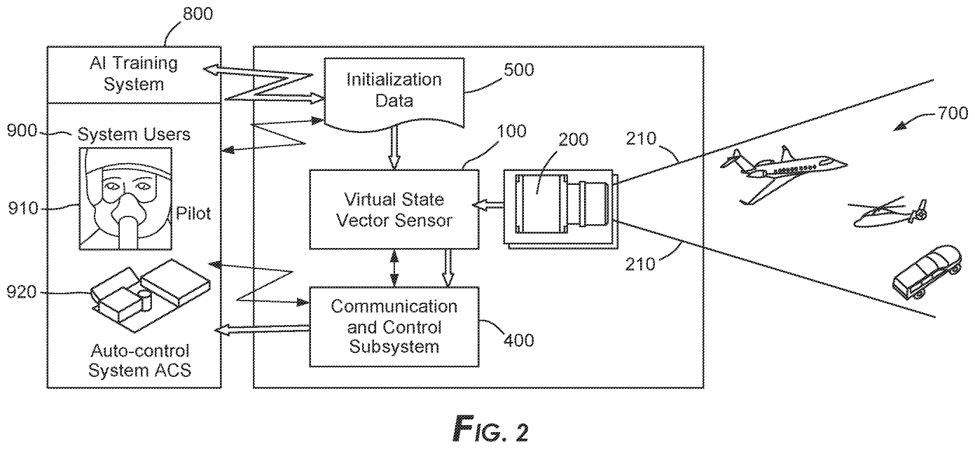

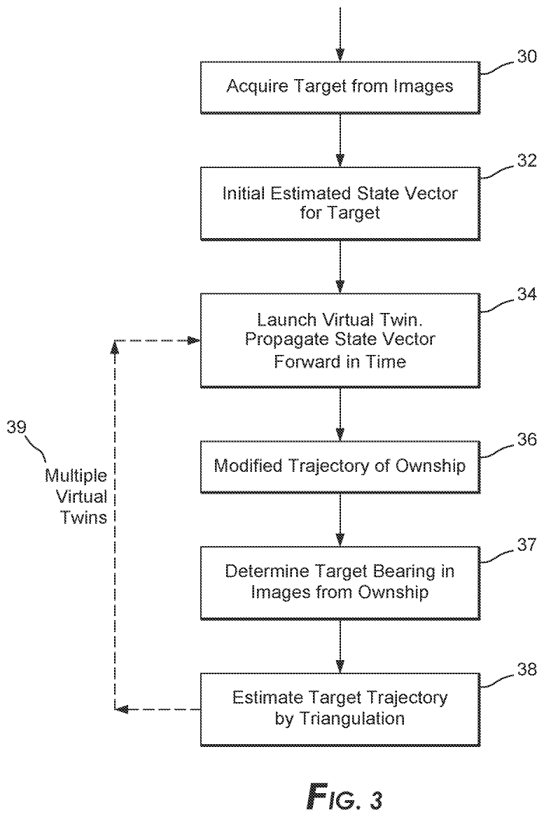

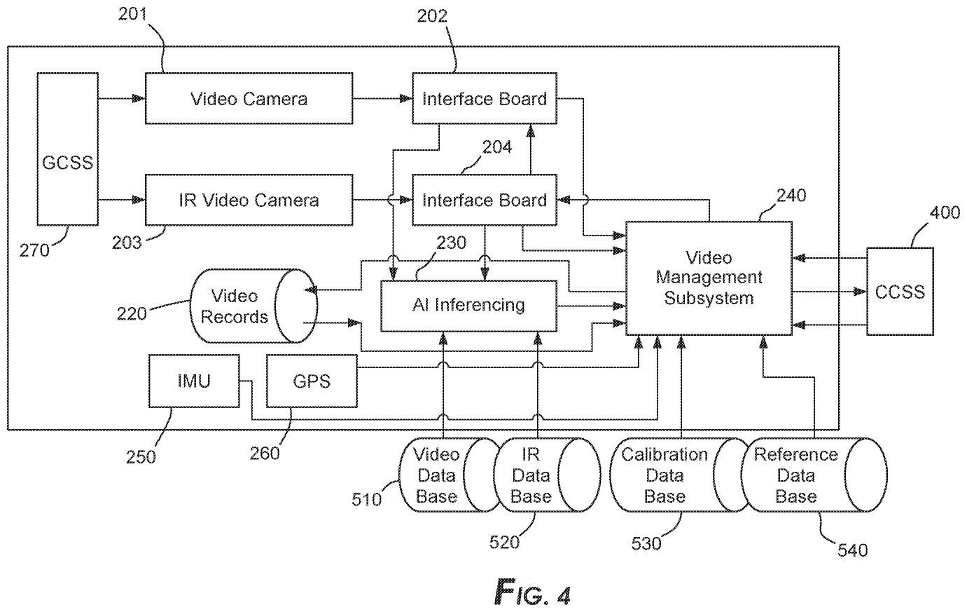

The system diagram of FIG. 2 shows a top-level view of the present system. A corresponding flowchart of the present invention is illustrated in FIG. 3. Returning to FIG. 2, the central component is the Virtual State Vector Sensor (VS² or VS2) 100 operating with inputs from the physical Camera Array (CA) 200. The CA consists of one or more visual and/or IR video cameras recording a physical field of view 210 with its video stream fed into the VS2 100. The physical field of view may be extended in its coverage either by a multiplicity of fixed cameras or by a gimbal and an associated gimbal control subsystem (GCSS) 270 shown in FIG. 4, which automatically tracks the target or targets. The Camera IMU 250 is a 6-dimensional Inertial Measuring Unit capturing the camera's 3-D displacement and 3-D rotation in real time.

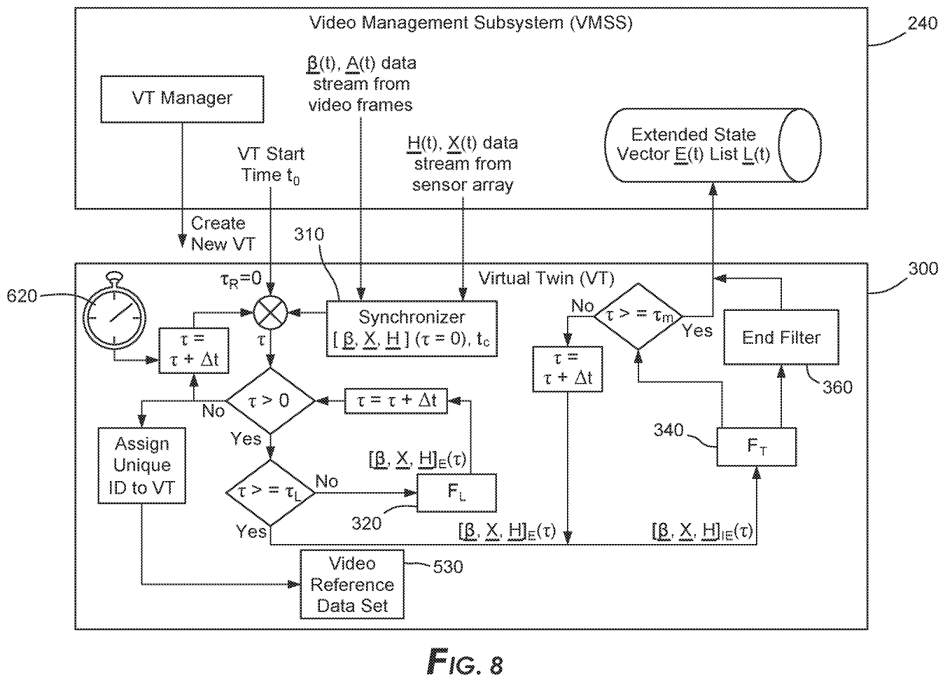

The CA 200 is assisted in 3-D triangulation by the Virtual Twin Array (VTA) 300 shown in FIG. 8, as will be discussed below. The VTA 300 can have an unlimited spherical field of view. Returning to FIG. 2, the operating parameters of the present system are initialized by the Initialization Data 500, defining the parameters of the VS2 100. The output of VS2 100 is a real-time data flow of the current state vectors of the targets 700 and their near-term forecasts. It is continuously fed into the Communications and Control subsystem (CCSS) 400 together with the optional compressed video output. The CCSS transmits these data in real-time to the System Users 900, including the Pilot 910 and the Auto-control System (ACS) 920. Pilot or ACS control inputs are transmitted into the CCSS 400 for execution by the VS2 100 through a bi-directional link.

Initialization data 500 originate from the system users 900 and include the artificial intelligence (AI) data needed to identify the target 700 classes of a particular implementation of the invention. The AI Training System 800 provides a large database through a link for target identification. Target classes (e.g., aircraft, helicopters, or ground vehicles) correspond to the learning imparted by the AI Training System 800 for a particular implementation of the invention.

The invention does not require detailed shape matching. Experiments performed by the inventors have shown that pixel counts in the order of 100 to 300 pixels are adequate for daylight video using contemporary artificial intelligence (AI) techniques; typically, a lower pixel count for IR video is adequate. The AI approach “trains” the neural nets used for target identification by presenting a large number of images of the targets. Training is too slow to be considered a real-time process. After the neural nets are trained, recognition (“inferencing”) takes a few tens of milliseconds and can keep up with video speeds. The AI neural nets in a prototype of the invention have been trained on images of multiple aircraft and UAV types to return a generic class of “aircraft.” Other generic classes have also been trained: “Hot air balloon”, “parachute”, and “helicopter” are examples.

Operation of the Virtual State Vector Sensor (VS2) 100. The following table lists the elements of the Virtual State Vector Sensor 100 and the various elements of the invention interoperating with the VS2 in FIGS. 2 and 4:

| Number | Description and/or Abbreviation |
|---|---|
| 201 | Video Camera or Cameras |
| 202, 204 | Interface Boards |
| 203 | IR Video Camera or Cameras |
| 220 | Video Records (Optional) |
| 230 | AI Inferencing |
| 240 | Video Management Subsystem (VMS) |
| 250 | Inertial Measuring Unit or Units (IMU) |
| 260 | GPS (GPS, DGPS, or other accurate |
| | positioning means) |
| 270 | Gimbal and Gimbal Control System |
| 510 | Video Evaluation Database |
| 520 | IR Video Evaluation Database |
| 530 | Calibration Database for 201 and 203 |
| 540 | Reference Database or Databases |
| | for 201 and 203 |
| 550 | Target ID Database |

The GPS elements 260 can be a commercial off-the-shelf subsystem. The video evaluation databases 510, 520 store calibration data of the camera arrays to determine optical axis bias and variance. The calibration and reference databases 530, 540 store application-dependent data to evaluate if an object sensed by the video and IR camera arrays is an object of interest. These may also include descriptive data of the application, timing parameters, and other relevant data. In particular, the video reference data set 530 includes Δt, τ_{L}, τₘ, presence or absence of filters, ID of the virtual twin and other control data to be used by the Virtual Twin.

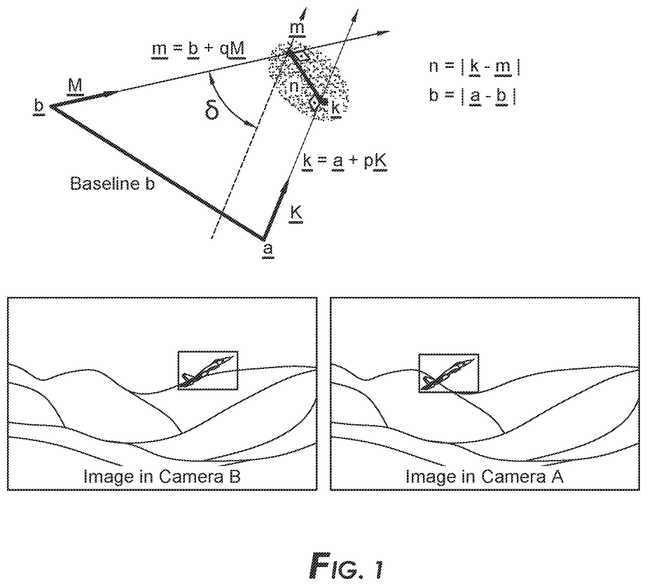

The present system is based on spatial triangulation, which requires at least two video cameras. At least one of the cameras is a physical video camera (Camera Array) 200. The second camera array is not a physical camera but a software entity, the Virtual Twin (VT) 300 of the physical camera array 200, performing as a second camera. Algorithms of the invention recognize potential targets 700 within the physical camera's field of view 210, including a “Bounding Box” (shown around the target images in FIG. 1), then compute its direction from each camera as a unit vector in a common global coordinate system. From the global directional vectors, the target's position is computed by 3-D triangulation (FIG. 1). These computations are probabilistic in nature. Target positions are obtained from simultaneous Camera Array 200 and Virtual Twin Array 300 video frame pairs. Each video frame is time-stamped, and the state vector of the target is continually estimated through stochastic filtering of the time series of the position estimates. The invention is independent of the stochastic filtering method.

Regarding the Video Evaluation Database 510, calibration data of the camera arrays determine the optical axis bias and variance. Regarding the calibration and reference databases 530, 540 for the video and IR video cameras 201, 203, application-dependent data may be used to evaluate if an object sensed by the camera arrays is an object of interest. These databases 530, 540 may include descriptive data of the application, timing parameters, and other relevant data.

Camera Array (CA) 200. FIG. 4 shows the components, data, and functions of the Camera Array 200. The video camera 201, as well as the IR video camera 203, is either a single camera or an array of several cameras integrated by the Video Management Subsystem (VMS) 240 into an equivalent single camera. The raw video is captured by the Interface Boards 202, 204. The interface boards transmit the video to the AI inferencing software (AIS) 230. The inferencing software compares the video frames with the video 510 or IR 520 databases and determines if one or more targets are present in the video frame. The video may be stored in the onboard video data store or directly transmitted to the system users at the user's option. The Inertial Measuring Unit (IMU) 250 and the GPS subsystem 260 determine each camera's location and attitude. The VMS 240 transforms the location of each target identified by the AI Inferencing software 230 within the camera's field of view into global coordinates with the aid of the IMU and GPS data. The optional gimbal and associated gimbal control system 270 implement the camera's rotation relative to its support structure by mechanical, piezo-electric, or other means. Its purpose is to keep a target, or a group of targets, within the limited field of view of the physical camera or multiple physical cameras. The 3-D gimbal rotations are generated within the gimbal control subsystem 270, creating an additional transformation matrix to transfer the camera coordinates to the airframe and/or global coordinates. The Inertial Measurement Unit 250 captures the real-time camera position and attitude changes and permits compensation for wing or fuselage flexing at the camera attachment point. The CA 200 interfaces with the Communication and Control Subsystem (CCSS) 400, receiving commands and returning to the CCSS its products: the target state vectors and forecasts in real-time as well as the optional video stream.

In particular, for consecutive video frames over time, the present system employs the following method of operation to identify possible targets:
(1) Continually update digital images captured by the sensors used by the present system. These sensors are generically referred to as digital video cameras, sensing electromagnetic waves reflected from, or originating at, its targets in the range of visible, ultraviolet, or infrared light, with the latter further categorized as short, medium, or long-wave infrared radiation, with such light not originating from the invention. Hereafter each image will be referred to as an image frame;
(2) Search for and recognize targets in each image frame by similarity to a set of example images of the same or similar objects (step 30 in FIG. 3);
(3) Construct the best estimate of the three-dimensional path of each target discovered, including the prediction of a most likely future path for each target;
(4) Verify that when an image of a target is discovered, it is either:
   (a) the same target already discovered and uniquely identified to a high likelihood, thereby continuing an already-discovered target's path,
   (b) a new target, or
   (c) if neither (a) nor (b) can be verified, then classifying the target as false positive;
(5) Perform the large majority of computations needed to reduce the very large number of digital image elements, commonly referred to as pixels, making up each image frame to a small amount of data describing the position, velocity, acceleration, and near-term path prediction of each target. Make such data continuously available to other systems for use in various specific applications, examples being collision avoidance with the targets or destruction of the targets.

Virtual Twin of a Camera Array. A Virtual Twin (VT) is a software object of a limited lifetime, typically a few seconds to a few tenths of a second. Its life cycle is divided into two phases. The life of a VT starts with its creation. At this point, it is associated with a physical camera and copies the position and speed vector of its physical twin, the physical camera array.

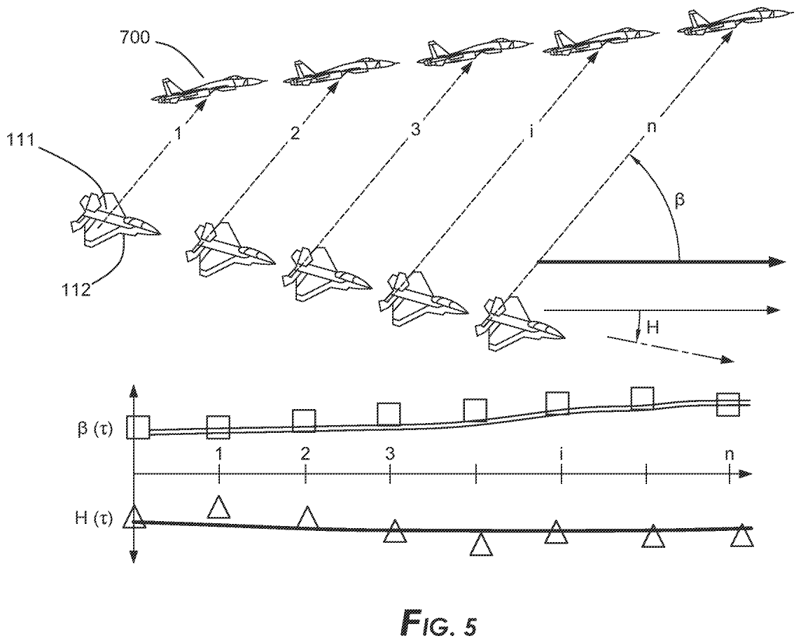

In the initial phase (FIG. 5), lasting through n video frames covering a time period tₙ, the VT “learns” from its physical twin to create an initial estimated state vector for the target 700 (step 32 in FIG. 2). The learning itself can take place through a stochastic filter which extracts an estimate of three variables: the two-dimensional bearing vector to the target b, the rate of change over time of this bearing \dot{β}, the two-dimensional heading vector of the real camera's optical axis vector H, and the three-dimensional estimate of the VT's position X and its speed vector V. During the phase I learning period, X and V are equal to the physical camera's X, V values and are not shown in FIG. 5. The time difference between measurement updates is Δt=tᵢ₊₁−tᵢ.

The number of video frames required for learning (n) is specified in the initialization data of the virtual twins (included in the calibration and reference databases 530 and 540). A default value, if not specified, is n=10. At the end of phase I, at τ=τ_{L} invention “launches” the virtual twin on the final heading estimate Hₙ (step 34 in FIG. 3).

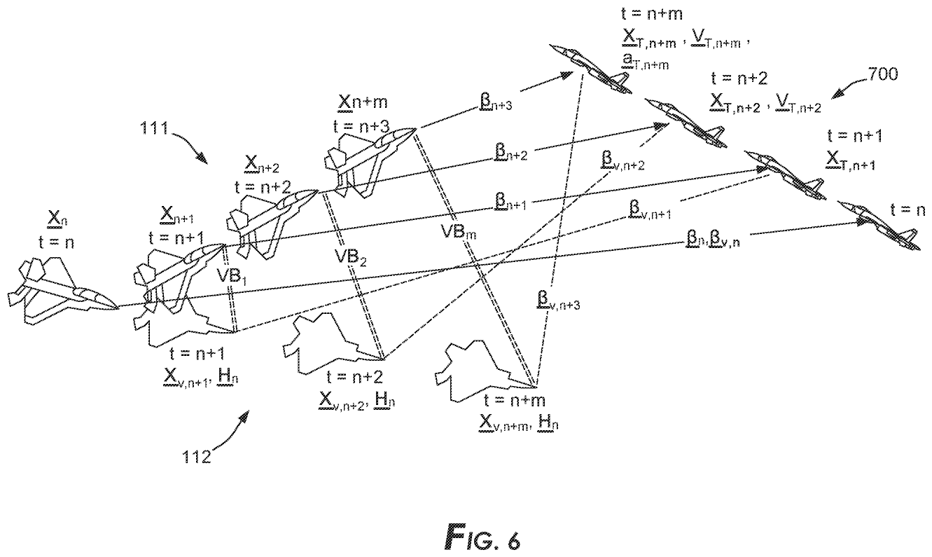

With the launch event of a Virtual Twin, phase II of the life cycle of the VT is initiated. In this phase, the invention continues tracking the virtual bearing of the target for some time, t_{VT,k} after its launch. In the notation t_{VT,k}, the index k refers to the unique serial number of the VT (the creation and launching of VTs takes place continuously, within pre-defined time steps Δt_{VT}). By propagating forward in time, the values of β, \dot{β}, H and X through a stochastic filter, the estimate of these values is obtained for each discrete time value in the second phase of the VT's life (see FIG. 6).

At the moment when the virtual twin is launched, the ownship enters a Virtual Assist Maneuver (VAM) (step 36 in FIG. 3). The command initiating the VAM is part of the real-time commands arriving from the CCSS. The invention is independent of the actual format of the VAM command. The VAM creates a new trajectory for the ownship, unknown to the virtual twin which was just launched. It also creates a new Virtual Twin that starts learning, in its phase I, how the target's bearing changes and the physical twin's heading and position over n video frames as seen from the physical camera.

The first virtual twin launched will create a 3-dimensional position estimate of the target, then continue to estimate the target's speed vector and state vector. Although the estimate assumes that the target moves on a straight-line trajectory, this is only a temporary assumption. Phase II of the Virtual Twin (VT) is illustrated in FIG. 6. The lifetime of phase II is m video frames over τₘ seconds; m is specified in an initialization file, with a default value of m=3n. The stochastic estimates evolve over the second phase of the VT life cycle by iterating at each time step to improve the previous time step's state vector estimate while also recomputing the covariance matrix between state vector elements until the VT's life cycle time tₘ is reached. If both visible light and IR video cameras are present in the camera arrays, these may have different covariance matrices. A final End Filter is applied to the separate IR and day video estimates to generate the Extended State Vector ET, which also includes a forecast of most likely target positions for a limited time period.

The operation of a Virtual Twin is illustrated in FIG. 6. A second virtual twin starting at t=n improves the state vector estimate S_{TE}(t), still assuming that the target moves in a straight line, but the direction of this straight line is not necessarily the same as the one assumed by the previous virtual twin, now in phase II. Later virtual twin launches will generate additional estimates of the target's state vector. In the general case, the invention considers the ownship, and therefore the physical camera, in turning flight.

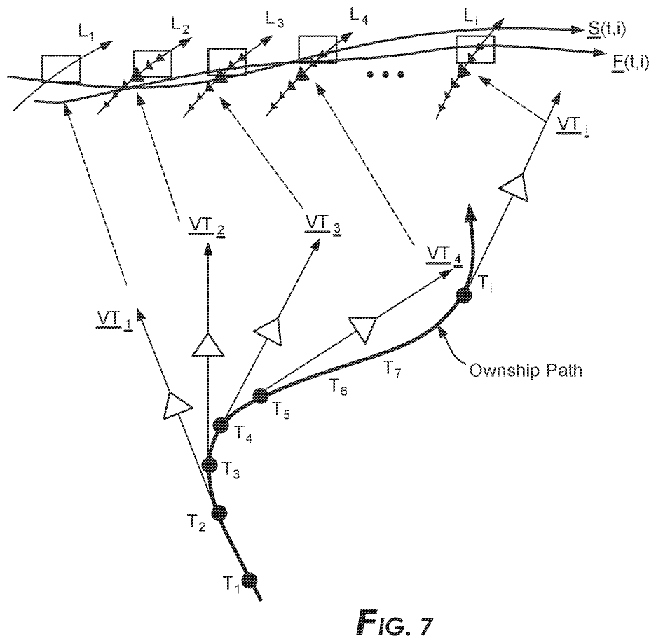

The invention continually generates iterative updates of the target's state vector and short-term forward estimates of the target's predicted trajectory by assuming that the target's trajectory is piecewise linear. The concept is shown in FIG. 7.

The lists L₁ . . . Lᵢ contain the extended target state vector estimates from successive virtual twins VT₁ . . . VTᵢ. The invention takes the approach of many digital instruments with internal Kalman (or other stochastic filters) and presents the estimates as measurement data. The invention regards the elements of the lists L₁ . . . Li as measurements of the target's state vectors S(t,i), covariance matrices C(t,i), and short-term forecasts F(t,i). The time period of each short-term forecast τ_{F} is defined in an initialization file, with a default value equal to the phase Il lifetime of the Virtual Twin that created the list Lᵢ, that is, τₘ.

The Virtual State Vector Sensor handles data originating from a Virtual Twin. Over the VT's phase II life cycle tm, the state vector estimate and its covariance matrix estimate are propagated. The covariance matrix will change based on the incoming virtual estimates. After tm, no more estimates are available, and the covariance values tend to increase.

These estimates originating from a single Virtual Twin are regarded as data coming from a state vector estimating instrument. The state vector estimates and covariance matrices arriving from each Virtual Twin are regarded as data and labeled as pseudo-data. They are inputs into a system-level stochastic filter Φ, which outputs a system-level state vector estimate with its covariance matrix. Short-term forecasts are then generated from these system-level estimates. This is the VS2 system of FIG. 2. Further detail on the Virtual Twin is shown in FIG. 8. A Virtual Twin is a software object that is created in multiple copies by the Video Management Subsystem (VMSS). It exists for a limited time and then can be destroyed by the VMSS.

From the VMSS, the VT receives the 3-D target bearing data stream β(t), the optical axis 3-D heading data stream A(t), and the 3-D position X(t) and 3-D attitude H(t) vectors of the ownship in real-time. Video frame updates come in at up to 30 frames per second, with their precise time markers supplied by the System Clock 620. Because multiple cameras may not get their new frames synchronized, the Synchronizer 310 software will bring them to a common time base. Further processing then happens at the VT-level relative time τ from the generation of the first synchronized frame set. The Synchronizer 310 corrects the raw relative time τ_{R}, set to zero by the Synchronizer 310 by the small correction t_{C}.

When τ=0, a unique identifier is assigned to the synchronized video frame, including the system time at which τ=0. With the next synchronized frame, the iterative “learning” process begins by feeding the video frames to the stochastic filter 320, F_{L}. Depending on the user-supplied Video Reference Data Set 530, the Learning Filter F_{L} 320 may be implemented as separate filters for IR and standard video frames. This iterative filtering continues until the time τ_{L} is reached, marking the Launch Event of the VT and the simultaneous start of the VMA maneuver.

With the Launch Event, the second phase of the Life Cycle of the VT begins. In this phase, the VT continues the path (X, H) learned from the physical camera arrays in phase I and keeps generating at each time step the bearing angles to the target learned in phase I learning of β and \dot{β}. This assumes the target continues on the same path during phase II as in phase I. This is not necessarily a straight-line path. For example, it could be continuing a constant-radius turn. FIG. 8 shows a single stochastic filter F_{T} 340 used in phase I and phase II. In the case of separate standard and IR video input streams, this single filter may be replaced, as a user option, by separate filters, F_{TV} for visual video data streams and F_{TI} for IR video data streams. The Fr filter or filters perform the spatial triangulation shown in FIG. 1 iteratively (step 38 in FIG. 3), improving the target's state vector estimates and its covariance matrices. The estimates include a forward estimate beyond the lifetime of the VT by t_{F} seconds. The Final Filter 360, which may be as simple as passing through the data and entering them into the Extended State Vector, will generate the Extended State Vector E_{T}(t). It is generated at each VT update cycle and forwarded to the Extended State Vector List in the VMSS for further processing, illustrated in FIG. 7. The elements of the Lists L in FIG. 7 are the Extended State Vectors.

The present invention uses a probabilistic approach that considers the target's likely flight or movement dynamics. The algorithms track the statistics of the angular and miss distance errors in the form of variances of the measured variables from the prediction models and the covariance matrices between the model coordinates. Optical flow, the movement of the image over the background, will further improve range estimates by tracking through background clutter. In FIG. 1, the likely miss position of the target can be visualized as a spheroid shape (or oval in two dimension) for a standard error. When the directional vectors K and M are obtained from a physical camera, they must be derived from a target within the field of view of that camera. When either one of these directional vectors is computed for a virtual twin, no such limitation applies because a virtual twin has an unlimited spherical field of view.

While certain specific structures and data flows embodying the invention are described, illustrated, and shown herein, those skilled in the art will recognize that various re-arrangements of the data flows and elements of the invention may be made. Such departures from what is described herein will not modify the underlying inventive concept, which is not limited to the specific structures, forms, and sequencing presented in this application.

User commands and displays are discussed below in greater detail. User applications include any commands the user, either manually or in an automated fashion, may specify as commands presented to the invention. Two potential command streams are indicated as possible inputs to the camera subsystem. The video and IR camera systems may be gimballed to continue tracking targets. In this case, the commands are converted to gimbal commands and presented to the video or IR camera systems via the respective interface boards. The other potential command is a “transmit video stream” on/off command.

Handling False Positives. These occur when new features not seen before have a likely target shape as perceived in a video frame at a location not perceived by an existing target's forecast. Only the physical cameras can discover new entities when such entities are within their field of view.

At the time of initial image capture, all targets may be false positives. Therefore, a new buffer is opened, with a flag indicating that it is temporary. If consecutive image captures, including analysis of the likely dynamics and optical flow, show a consistent target trajectory, a new target is identified; otherwise, the buffer is removed as a false positive.

False Negatives. A false negative occurs when no target image is identified in the approximate location the forecast model expects for an existing target. In this case, the forecast propagates the target with somewhat increased variance at each time step. If, after an installation-dependent time delay, no target shows up within the predicted locations and with a state vector that can be rationally derived from the target's earlier behavior, the target buffer is removed from the invention.

Passive Ranging with Single Ownship. With a single physical camera mounted on the ownship platform, an arbitrarily large virtual baseline may be built up between the physical camera and its virtual twin. A Virtual Twin is a pure software entity. It updates its computed position by continuing the ownship trajectory estimated before launching the virtual twin. It updates its directional vector towards the target based on pre-launch estimates of how its view direction toward the target changes over time. After a sufficient startup period (typically the time it takes to acquire 10 to 30 new video frames), this estimate is established with sufficient accuracy, and the virtual twin is launched (step 34 in FIG. 3). At the same moment, the ownship starts a direction change to build a virtual baseline (step 36 in FIG. 3), seen as the distance between points 3 (the physical camera position) and V3 (the virtual camera position). After the ownship 111 modifies its trajectory, its physical camera array 200 continues to record images that can be used to determine the bearing of the target 700 with respect to the ownship 111 (step 37 in FIG. 3). As the time from launch increases, the virtual baseline becomes the distance from Point 4 to V4, then Point 5 to V5, etc. While the larger baselines and view angles d4 . . . d6 would result in increased distance accuracy and other state vector elements, the passage of time from launch increases the uncertainty of the location of the virtual positions V1. . . . V6 and later virtual positions. This makes it necessary to launch newer and newer virtual twins (see FIGS. 7 and 8) to keep up with tracking a target that may not move in a straight line.

Multiple Cameras for Extended Field of View. Optionally, multiple cameras can be installed on a small UAV with an angular overlap to provide an extended field of view. This arrangement was demonstrated in an early prototype of the invention, when paired cameras were mounted on each wingtip of a light sport aircraft 10.6 m apart, with an 80° horizontal field of view. One camera of each pair was aimed forward; the other was rotated 75° outboard relative to the forward-looking camera. The algorithms of the invention had no trouble covering the resulting 155° horizontal field of view at each wingtip.

Tracking Multiple Targets. Tracking two or more targets is similar to tracking a single target. The invention's artificial intelligence and/or optical flow components perform image recognition and tracking. The VS2 and VMSS components of the invention will handle each target discovered.

Implementation-Dependent Supporting Subsystems. Implementation-dependent supporting subsystems shown in FIG. 2 are optional components of the invention. They are necessary to provide data required by the invention, but they are dependent on the application of the invention for purposes the invention's user desires. The functions of three such subsystems are discussed below for completeness in understanding how the invention will use their products.

Video Database Generation. This subsystem, which may be a complete system in itself, generates the video database used in inferencing the recognition of the targets or target classes. The detailed requirements for generating the database depend wholly on the intent of the invention's user. For example, if the intent is to recognize a specific type of target, such as “Fighter Aircraft Type XYZ,” the input to the video database generation subsystem would most likely be a large number of video images taken in flight of Type XYZ in different relative attitudes, at different distances, over different backgrounds in varying seasons and light conditions. The Video Database Generation Subsystem then would use Artificial Intelligence (AI) methods whose output, the video database, is compatible with the inference methods of the invention. Because the invention itself does not specify the AI methods used for target recognition (that is, inferencing), it is up to the user of the invention and its supplier to agree on the details specifying a common approach, including interface specification and method specification.

IR Video Database Generation. IR Video Database Generation is similar in detail to the Video Database Generation described above. The details will only be different because IR video images will likely contain temperature information. Our prototypes show that the size of the pixel field showing an IR image adequate for recognition may differ from the size needed for visual light video image recognition.

Calibration Database Generation. The calibration database is necessary to transform the pixel coordinates of the image sensor to unit vectors in the global coordinates of the particular application of the invention. The global attitude coordinates, as measured by the IMU and GPS combination, may not be perfectly aligned with the optical axis vector of the camera or cameras. As a result, the pixel coordinates may be somewhat uneven. A calibration subsystem can identify these alignment differences and will be recorded in a calibration database. For production applications in which the invention is permanently installed on a host platform (ownship), periodic recalibrations may be necessary as part of the platform's maintenance process. For research and development applications where the invention may be temporarily attached to a host platform, calibration will be necessary before and after every use. The exact calibration method used is outside the invention's scope.

User Applications. User applications, like supporting subsystems, are optional components of the invention. They make the invention useful from its user's point of view by using the invention's output, that is, the stream of target state vectors and/or the video stream. The applications may range from a collision avoidance display to a targeting display or an automated collision avoidance or target engagement system. User applications may also include commands to the invention, for example, video camera gimbal commands, if the camera subsystem is so equipped.

Edge Processing. Edge processing is a key element in stealthy target acquisition and tracking. Edge Processing refers to processing sensory information as close to a sensor as possible. Its main advantage is reducing often very voluminous sensor data to generally much smaller, usable data sets. In the case of the current invention, the sensory data are Forward-looking Infrared (FLIR) and daylight or UV video frames. Each frame contains millions or tens of millions of pixels. Depending on the sensor, each pixel has 1 to 4 bytes of information. From a sensory input of tens of millions of bytes in a pixel frame, the invention extracts, for each target, a state vector taking up approximately 100 bytes.

The method of the invention reduces the sensory input stream from the cameras, which ranges from approximately ten million bytes per second to one hundred billion bytes per second to a data stream in the order of 103 bytes per second. This bandwidth reduction has significance for tracking non-cooperating targets while not revealing ownship presence for tracking by a pair or group of aircraft and in implementing a key claim of the invention: long-range tracking by a single aircraft.

Example of Processing Stochastic Variables. For a clearer understanding of the stochastic computation processes of the invention, we present a simple example of how random errors affect computations. We are considering the initial launch of a Virtual Twin from a small and slow UAV against a similar target at approximately 2.2 km range Ownship speed is 48.6 KTAS, target speed is 62.2 KTAS. The invention itself has no speed limitations; it will work at supersonic or even orbital speeds.

The ownship starts on a course of 360°, with the target within its field of view, and maintains this course for 1 second, collecting 10 heading measurements and 10 bearing measurements towards the target. The heading and bearing measurements have a normal distribution, with a standard deviation of 0.25° and 0.15°, respectively.

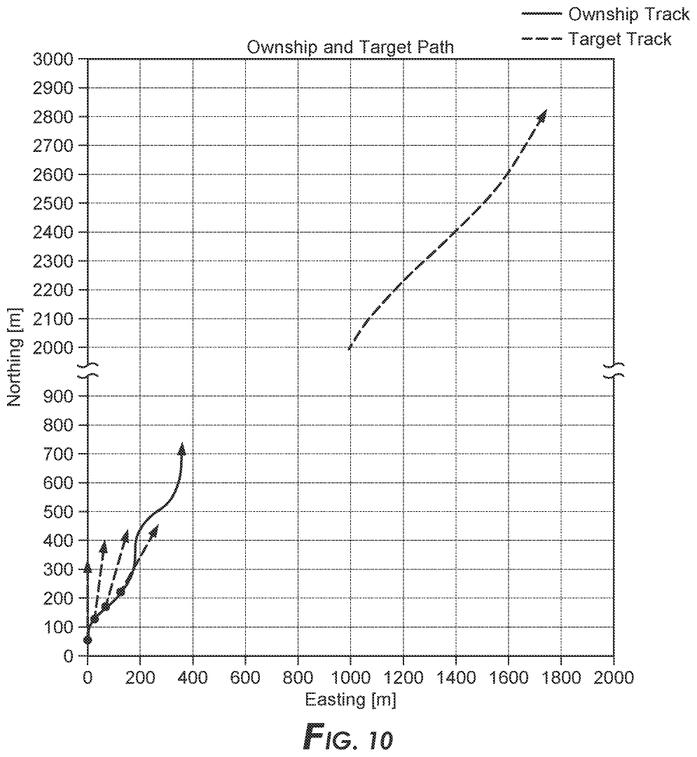

FIG. 10 shows the ownship and target tracks. After one second, the ownship launches the first virtual twin (the back arrow pointing to the north) and begins a right turn for launching subsequent virtual twins. The target follows a slightly curving path, starting at 2000 m Northing and 1000 m Easting relative to the ownship's start point.

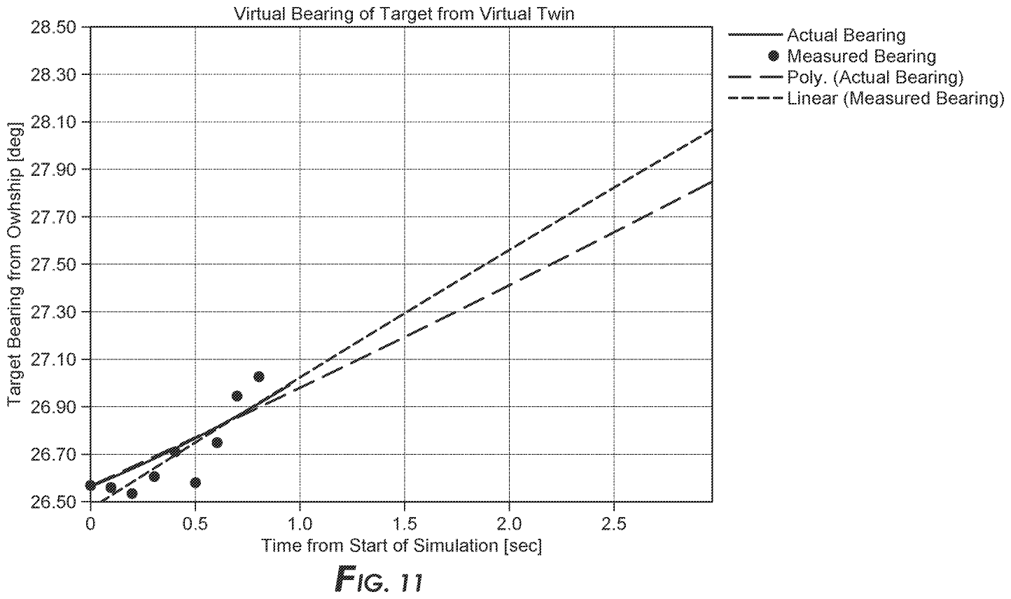

FIG. 11 shows the theoretical, discrete target bearing history as seen from the ownship with no errors. The virtual bearing of the target at the time of launch is 26.93 degrees, and 4 seconds later, it is 28.82 degrees. This is an ideal case, with no errors, shown by the solid line and extended into the future by the dashed line. The dots show one possible series of measurements with the standard deviations mentioned earlier. In the case of this example, we used a linear least squared error estimate for forward propagation. Four seconds after the launch of the virtual twins, the predicted bearing to the target is 29.15 degrees; that is, we now have a 0.33 degree error. The virtual baseline at that point is approximately 160 meters, yielding a parallax of 4.1° with a potential range error of 8%. The magnitude of this error depends on the bank angle limitations of the ownship and the combined field of view of the cameras. A larger field of view and greater permissible bank angle result in a more precise estimate with the same standard deviations of angular measurement accuracy. The example above used a small UAV bank angle limitation of 20°.

The invention does not specify the method by which we compute estimates from data with random errors. In the above example, we used a least squared error estimate (which is not recursive). However, any other, preferably recursive stochastic filtering method, such as a Kalman filter, may be used to generate extended state vector estimates of the target motion.

Multiple Ownships. The present invention can be extended to accommodate a multiple-platform mode in which a plurality of ownships are deployed, each with its own series of Virtual Twins.

Preparations start with the human or automated user sending the Initialization Database 500 to the system through a two-way datalink. The system then determines if it will operate in the multi-platform or single-platform mode. If the multi-platform mode is selected, the process transfers to the multi-platform or swarm processing. The choice of single or multi-platform mode is signaled to the user through a link. To start single-platform scanning, the user sends the “start scanning” command to the system. If, for any reason in the user's determination, scanning should stop, a “stop scanning” command is sent.

A Video Manager Process is performed in parallel for each target currently in the target list. Two computational loops are controlled by this video manager process. Each of these loops produces estimates of an Extended State Vector (ESV).

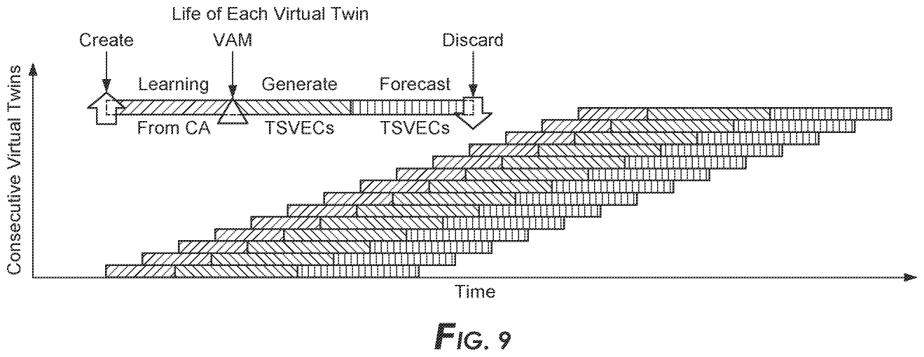

The Virtual Twin ESV Loop (VTESV Loop) of the Video Manager Process initializes, then launches a Virtual Twin and computes a Virtual Twin ESV as long as the physical Camera Array (CA) can find a target within its field of view. Each target goes through false positive and false negative check processes, either validating or removing it from the target list and destroying its unique Target Identification (TID). For each valid target, multiple, short-lived Virtual Twins are prepared and launched at time intervals Δt_{VT}, as defined by the initialization data. For aerial platforms, typical values of the Δt_{VT} interval are in the order of one second but not less than the acquisition time of a predetermined number of video frames (typically 10 or more frames). The overall life cycle of each VTESV loop is several times the Δt_{VT} interval, as discussed above. Consequently, several VTESV loops (and several virtual twins) are active for each target, as illustrated in FIG. 9 (step 39 in FIG. 3). The output of the VTESV loop is a series VTESVs computed at time intervals of Δ_{T}, the invention's computational update interval. Each Virtual Twin Extended State Vector contains the associated target's State Vector Estimate, its Covariance Matrix, and the short-term forecast of the target's State Vector. This output, referred to as a “List” L when the loop is completed, is passed on to the Virtual State Vector Sensor software for processing in the System Level Extended State Vector Estimation Loop.

The System Level Extended State Vector Estimation Loop (SLESV Loop) and the associated Virtual State Vector Sensor software process each VTESV Loop's output, designating each completed loop's output as Li, the index i indicating each completed VTESV loop. The elements of Li selected for further processing may be selected by any method that satisfies the user. With the following default methods defined in the Initialization Database 500:
(a) Element m in the list Lᵢ, designated as Li,m, has the most reliable state vector S_{i,m} as evaluated through the corresponding covariance matrix Ci,m. (The evaluation process may be any acceptable evaluation process that accounts for the state vector itself becoming better and better defined as m increases, while the covariance matrix indicates less and less reliability as m increases).
(b) The short-term forecast from either the last element of the list Li or from a selected element m of that list (as further defined by the initialization data) is selected as the short-term forecast input for further processing.

These data are then regarded as input data for the stochastic filter Φ. The estimate model of the filter Φ should consider the likely Newtonian dynamics of the target's speed, velocity, acceleration, bearing, and bearing rate in a 3-dimensional environment. The initialization data may offer specific filter models, for example, a linear or unscented Kalman filter. The output of the SLESV loop is the State Level Extended State Vector Estimate of each target.

Stochastic Estimation of 3-Dimensional Target Position by Triangulation. A brief description of three-dimensional triangulation was presented above for a practical case in which the bearing lines from two separate observers to an observed target are unlikely to meet at any single point in space due to the likely inaccuracy of the 3-dimensional bearing measurements. This immediately implies that we are facing a stochastic process in three dimensions. To better understand our approach, we first state that there is no essential difference from the two-dimensional case. Although in the two-dimensional case, the bearing lines will intersect, the bearing lines still have a measurement error. Therefore, the computation of the target position is still a stochastic process, whether this is recognized or not.

For example, in the two-dimensional case, the Camera Array CA may capture a video frame containing the target in which the directional error is high, around 2σ off of CA's optical axis. The Virtual Twin VT may see the target with a smaller error. The position of CA is known with some possible error. The variance in the position of VT increases with time after its launch, and may be larger than the variance of CA. An additional error is clearly introduced in the angular measurements by the position errors of VT and CT, which is expressed in the covariances. The three-dimensional solution is analogous to the two-dimensional approach.

The essence of the stochastic filtering approach is the same. Initially, the errors are high. As time passes, the filter learns from the measurements and updates its model (the estimates) until they settle down to a more or less constant level of variance. At the start of the filter, the errors are high—for example, a single position estimate will not yield velocity. As time passes, more information is extracted, and the variances decrease. When measurements are no longer available, for example, when predicting the future, most likely values of a target's state vector, the covariance matrices, including the variances of the individual variables, will increase.

The invention takes advantage of this prediction capability of stochastic filters, which makes it possible to launch the Virtual Twins with high confidence and use them as another measurement while their likely errors are low.

All of the elements of the invention do not need to be present in each application. For example, the System Level Extended State Vector Estimation Loop (SLESV) may be omitted either for collision avoidance or target state vector estimates when the target aircraft is not maneuvering violently. When the processes described are used in a swarm or cooperative aircraft groups and when targeting and communications are available within the swarm, the virtual twin component is replaced or augmented by the actual 3-D bearing data provided by the swarm or group elements, and the ownship maneuvers become optional.

In summary, the present system can passively detect, track, and predict the future position of targets in the space surrounding the point of observation. When mounted on a single platform, the present system can create virtual baselines for automatically predicting position, velocity, acceleration, and short-term future movement of non-cooperating aerial, space, and surface targets. The present system is not misled in range and state vector estimation by the geometric similarity between valid targets and accidental or intentional scale models. The present system can predict trajectories of targets without a priori knowledge of such trajectories, nor does it require a priori knowledge of target size and shape. The present system does not emit any mechanical or electromagnetic waves to perform the detection, tracking, and prediction of the future trajectory of targets. It can be mounted on ground-based or air-or space-borne vehicles and track and predict the movement of ground-based or air-and space-borne targets. In addition, the present system significantly reduces data flow volume from real-time video imagery to necessary data for collision avoidance or engagement of targets.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A method for determining the trajectory of a target comprising:
(a) acquiring a time series of images of a target from a camera on a moving platform (ownship) having a known bearing and velocity;
(b) determining an initial estimated state vector for the target, including the bearing of the target with respect to the ownship, based on the time series of images;
(c) simulating the launch of a virtual twin of the ownship by propagating the state vector forward in time along a predetermined path continuing that of the ownship to generate a time series of updated state vectors for the target;
(d) modifying the trajectory of the ownship to follow a path different from that of the virtual twin to thereby create a baseline separation between the ownship and virtual twin for observation of the target;
(e) acquiring a time series of images of the target from the ownship moving along the modified trajectory, synchronous with the time series of updated state vectors for the virtual twin;
(f) determining the bearing of the target with respect to the ownship in the time series of images along the modified trajectory; and
(g) estimating the trajectory of the target by triangulation based on the paths of the ownship and virtual twin, and the time series of bearing data from the ownship and virtual twin.

2. The method of claim 1 further comprising the initial steps of:
acquiring images from a camera on the ownship; and
scanning the images to detect a target.

3. The method of claim 2 wherein a neural net is used to detect a target in the images.

4. The method of claim 1 wherein the virtual twin follows a linear path continuing the path of the ownship at the time of launching the virtual twin.

5. The method of claim 1 wherein the step of propagating the state vector forward in time is performed by a stochastic filter.

6. The method of claim 1 wherein the step of propagating the state vector forward in time is performed by a Kalman filter.

7. The method of claim 1 further comprising launching a sequence of virtual twins of the ownship at intervals over time by repeating steps (c) through (g) as the ownship proceeds.

8. The method of claim 1 wherein the state vector comprises the bearing of the target, the rate of change over time of the bearing of the target, and the position and velocity of the virtual twin.

9. The method of claim 1 wherein step of estimating the trajectory of the target by triangulation is performed by a stochastic filter.

10. A method for determining the trajectory of a target comprising:
acquiring a time series of images of a target from a camera on a moving platform (ownship) having a known bearing and velocity;
determining an initial estimated state vector for the target, including the bearing of the target with respect to the ownship, based on the time series of images; and
simulating the launch of a plurality of virtual twins of the ownship at intervals over time as the ownship proceeds, for each virtual twin:
(a) propagating the state vector forward in time along a predetermined path continuing that of the ownship to generate a time series of updated state vectors for the target;
(b) modifying the trajectory of the ownship to follow a path different from that of the virtual twin to thereby create a baseline separation between the ownship and virtual twin for observation of the target;
(c) acquiring a time series of images of the target from the ownship moving along the modified trajectory, synchronous with the time series of updated state vectors for the virtual twin;
(d) determining the bearing of the target with respect to the ownship in the time series of images along the modified trajectory; and
(e) estimating the trajectory of the target by triangulation based on the paths of the ownship and virtual twin, and the time series of bearing data from the ownship and virtual twin.

11. The method of claim 10 further comprising the initial steps of:
acquiring images from a camera on the ownship; and
scanning the images to detect a target.

12. The method of claim 11 wherein a neural net is used to detect a target in the images.

13. The method of claim 10 wherein the virtual twin follows a linear path continuing the path of the ownship at the time of launching the virtual twin.

14. The method of claim 10 wherein the step of propagating the state vector forward in time is performed by a stochastic filter.

15. The method of claim 10 wherein the step of propagating the state vector forward in time is performed by a Kalman filter.

16. A method for determining the trajectory of a target comprising:
acquiring a time series of images of a target from a camera on a moving platform (ownship) having a known bearing and velocity;
determining an initial estimated state vector for the target, including the bearing of the target with respect to the ownship, based on the time series of images;
simulating the launch of a virtual twin of the ownship by propagating the state vector forward in time along a predetermined path continuing that of the ownship to generate a time series of updated state vectors for the target using a stochastic filter;
modifying the trajectory of the ownship to follow a path different from that of the virtual twin to thereby create a baseline separation between the ownship and virtual twin for observation of the target;
acquiring a time series of images of the target from the ownship moving along the modified trajectory, synchronous with the time series of updated state vectors for the virtual twin;
determining the bearing of the target with respect to the ownship in the time series of images along the modified trajectory; and
estimating the trajectory of the target by triangulation based on the paths of the ownship and virtual twin, and the time series of bearing data from the ownship and virtual twin.

17. The method of claim 16 further comprising the initial steps of:
acquiring images from a camera on the ownship; and
scanning the images to detect a target.

18. The method of claim 17 wherein a neural net is used to detect a target in the images.

19. The method of claim 16 wherein step of estimating the trajectory of the target by triangulation is performed by a stochastic filter.
